(19) United States
(12) Patent Application Publication
(10) Pub. No.: US 2019/0126726 A1
(43) Pub. Date: May 2, 2019

(54) AIR VENT WITH A DEVICE FOR CONTROLLING AN AIR FLOW

(71) Applicant: DR. SCHNEIDER KUNSTSTOFFWERKE GMBH, Kronach (DE)

(72) Inventors: Olaf UHLENBUSCH, Marktzeuln (DE); Matrane KAMAL, Dortmund (DE)

(21) Appl. No.: 16/094,189

(22) PCT Filed: Apr. 11, 2017
(86) PCT No.: PCT/EP2017/058598

§ 371 Date: Oct. 16, 2018

(30) Foreign Application Priority Data
Apr. 19, 2016 (DE) 10 2016 107 227.3

(51) Int. Cl. B60H 1/34

(52) U.S. Cl. CPC B60H 1/3414; B60H 2001/3471; B60H 2001/3464

(57) ABSTRACT

An air vent (10) with a device for controlling an air flow is described. The air vent (10) has a housing (12) which surrounds an air duct (16) at least in sections, and has a displacement body (32) mounted pivotably in the housing (12). The housing (12) has an air inlet portion (20), a central portion (22) and an air outlet portion (24), wherein the cross section of the air duct (16) is reduced from the central portion (22) towards the air outlet portion (24). The displacement body (32) is pivotable about a pivot axis (D) running parallel to an air outlet opening (26) provided in the air outlet portion (24), and is of drumstick-like design at least in sections.

An air vent with a device for controlling an air flow is described, wherein the air vent comprises a housing, which surrounds an air channel at least in a section, and an element pivotably mounted therein, wherein the housing has an air inlet section, an centre section and an air outlet section and the cross-section of the channel reduces starting from the centre section towards the air outlet section. The air vent can be used as an air vent in vehicles. Vehicles include, not exhaustively, motor vehicles, such as cars, trucks, buses and agricultural vehicles, trains, aircraft and ships. The air vent can be used as, in particular, a gap air vent in a dashboard of a motor vehicle. Gap vents extend over a large length by comparison with their height. The height as a rule is also selected in such a way that it does not exceed, for example, 20 millimetres.

Various air vents with a pivotably mounted element are known from the prior art.

Such an air vent is disclosed in DE 10 2007 019 602 B3, in which a substantially conical air guide element is arranged in an air channel. The housing of the air vent is constructed in such a way for the air channel and the conical air guide element that air deflection can be achieved with utilisation of Coanda effect. However, the design of air vent disclosed in DE 10 2007 019 602 B3 does not enable deflection of an air flow over a wide range of adjustment. The adjustment range of the deflection defines the extent to which air deflection upwardly or downwardly, for example departing from a vehicle dashboard, can be carried out. The demands placed on air deflection are thus very high for the manufacturer. As a rule, air deflection upwardly and downwardly through at least 45 degrees should be achieved starting from an air flow output in a neutral setting.

An air vent is disclosed in FR 2 872 260 A1 which comprises a ventilation channel with an outlet section defining an outlet opening, the air vent additionally having an air guide element which is arranged in the outlet region to be movable between at least two ventilation settings.

FR 2 915 137 A1 discloses an air vent with a pivotably mounted air guide element. The air guide element is of conical construction and connected with a ring by way of a retaining arm. The ring is supported on air channel walls of corresponding construction and enables pivotation of the air guide element in all directions. In addition, the air guide body is displaceable by way of the retaining arms relative to the ring, as a result of which the amount of air that is issued can be regulated. The air guide element has at the front end an actuating element which projects from the air channel and can be gripped by a user. Motorised activation is not possible, because the air guide element is movable three-dimensionally. The actuating element is therefore an essential component.

DE 10 2013 210 055 B3 discloses an air vent with a rigidly constructed air guide element. The air guide element is arranged in an air channel and comprises a lever arrangement with a control element projecting from an air outlet opening. A blade connected with the control element via the lever arrangement is arranged at the air guide element at the rear side. The blade enables air distribution in a first section and a second section, the sections extending between the air guide body and the opposite channel walls.

It is therefore the object to indicate an air vent which comprises a pivotably mounted element and by which air deflection over a wide range of adjustment is possible.

The object is fulfilled by an air vent with the technical features indicated in claim 1. Advantageous developments are indicated in detail in the subclaims.

An air vent with a device for controlling an air flow, which fulfils the afore-mentioned object, is evident on the basis of the features of claim 1.

The air vent is constructed with a device for controlling an air flow, the air vent being constructed as a gap air vent and having a small height by comparison with its width. It comprises a housing, which surrounds an air channel at least regionally, and a displacement body pivotably mounted in the housing. The housing has an air inlet section, a centre section and an air outlet section and the cross-section of the air channel reduces starting from the centre section towards the air outlet section. The displacement body is pivotable about a pivot axis, which extends parallel to an air outlet opening provided in the air outlet section, and has at least regionally a lobar shape in cross-section of the air vent perpendicularly to the pivot axis. The displacement body is arranged completely within the air channel and extends over the width of the air vent.

The displacement body makes possible, apart from direct deflection of inflowing and outflowing air, acceleration of the exiting air through reduction in the air channel cross-section as a consequence of the change in the spacing of the displacement body from the channel walls of the air channel. The at least regional lobar formation of the displacement body takes into consideration the deflection to be achieved and the construction of the air channel. The air vent is conceived so that for deflection of an output air flow in its maximum deflection settings, i.e. upwardly or downwardly, a greater acceleration of the exiting air flow takes place. Such a construction is not disclosed in DE 10 2007 019 602 B3. The air vent described therein makes it possible only to deflect air in a small range of adjustment. Moreover, the air vent shown in DE 10 2007 019 602 B3 is constructed as a ball vent and the air guide element is mounted to be tiltable and rotatable by way of an area element which surrounds at fixed spacings.

In the case of the air vent described herein, the displacement body is mounted to be pivotable about only one pivot axis and does not have any additional spacing elements for mounting and for deflection of the air. The result is a very simple construction of the air vent, which comprises a displacement body arranged in an air channel with an air inlet section, a centre section and an air outlet section.

The displacement body can have at least a first section and a second section, the first section being of club-like configuration and the second section having a smaller thickness by comparison with the first section. In further forms of embodiment the second section has a section tapering to a point. The section tapering to a point can extend over at least a third and in further forms of embodiment over half of the displacement body along the flow path of the air flowing through the air channel. For preference, the section tapering to a point is constructed in such a way that this has a substantially parallelly extending section. The parallelly extending section is the region of the second section of the displacement body having the same thickness. At the end of the second section opposite the club-like section the second section can have an edge which is rounded or tapers to a point. In further forms of embodiment sealing elements can be arranged at this edge or the rounded end section. Sealing elements are, for example, a rubber or silicone lip or a specific coating with sealing materials such as, for example, silicone. The club-like first section is formed to be rounded at the end remote from the second section. In further forms of embodiment the first section has such a configuration in this region that the displacement body has a cross-section in the form of a semicircle. Inflowing air or outflowing air can flow along this rounded region without generating turbulence.

The transition between the first section and the second section of the displacement body can drop away flatly or steeply. The configuration of the transitions is dependent on the configuration of the displacement body. The configuration of the sections in that case ensures that turbulence is not imparted to inflowing and outflowing air.

The pivot axis of the displacement body can extend through the first section. Since the displacement body usually has a higher weight in the first section than in the second section, the displacement body then does not have a tendency to independently tilt due to the weight of the first section. The first section of the displacement body is always arranged at a spacing from at least two opposite channel walls of the air channel in the region of the centre section. If the displacement body is pivoted about the pivot axis then the air flow can be cut off by way of the second section either above or below the displacement body in extreme settings of the displacement body, as a result of which there is acceleration of the exiting air flow in the remaining passage between a channel wall and the displacement body.

The first section of the displacement body can be arranged to face the air inlet section or the air outlet section. If the first section faces the air inlet section then in a number of embodiments the transition between the first section and the second section is formed to fall away steeply. Air flowing in by way of the air inlet section is deflected by the curved form of the first section and then flows, following the curvature of the first section, against the channel wall or channel walls of the air channel. If the first section faces the air outlet opening then in a further number of embodiments the transition between the first section and the second section is formed to fall away flatly. Air flowing in by way of the air inlet section flows along the displacement body and is continuously deflected. The air flow subsequently follows the curvature of the club-like first section and passes from there to the channel wall or walls, as a result of which deflection of the outflowing air takes place due to the further curvature of the channel walls.

The displacement body can be of either hollow or solid construction. A hollow displacement body has a lower weight by comparison with a displacement body of solid construction. In order to achieve sufficient strength and stability relative to deformation and for the journalling of elements for pivotation of the displacement body a support structure or similar can be provided within a hollow displacement body. A hollow displacement body can be of integral construction. In that regard, a form of film hinge can be provided for the mounting of two halves of the displacement body. On the other hand, two half shells of a displacement body can also be clipped or welded together.

The air outlet section can have, in the region of the air outlet opening, transitions with an edge. The transitions with an edge ensure that the air flows exiting by way of the air outlet section follow the curvature of the air channel through the cross-sectional reduction from the centre section to the air outlet section. The edges can be formed in such a way that these have a small radius.

Curved outlet sections can adjoin the air outlet opening. The curved outlet sections assist deflection downwardly and upwardly with utilisation of Coanda effect. The curved outlet surfaces make possible, with utilisation of Coanda effect, onward flow of the exiting air flow out of the air outlet opening even when the displacement body is disposed in such a middle setting that an air flow which is as straight as possible exits from the air vent, in which case the exit velocity of the air is decisive for whether such a deflection occurs due to the outlet surfaces, i.e. at low air velocities a wide fanning out of the air flow is possible.

The air channel can have a smaller diameter in the region of the air inlet section than the air channel in the region of the centre section. As a result, there is a small reduction in the velocity of the entering air flow. In addition, flow of the inflowing air along the channel walls is achieved primarily in the centre section and in the air outlet section.

The displacement body can in addition be coupled with an electric motor. It is thereby possible to provide, by way of button elements or other control devices, pivotation of the displacement body for setting the outflowing air without mechanical control elements such as, for example, a setting wheel, which in the alternative can be used in further forms of embodiment. The air vent can be constructed as, in particular, a so-called gap air vent. Gap air vents are used in, for example, a vehicle dashboard and extend over a defined width, preferably over at least 300 millimetres. An advantage of gap air vents is that no slats are visible from the front (‘concealed’ or ‘invisible’ air vents), not even those which were needed for vertical air deflection in the background. Through segmentation of club-like displacement bodies or displacement bodies with club-like sections even curved or three-dimensional gaps can be supplied with air.

The components of the air vent, namely the housing as well as the displacement body, can be made from plastics material and thus have a low weight. In addition, it is possible to produce the components rapidly and economically in large batch numbers.

The air vent described herein has a very simple construction and enables air deflection over a wide range of adjustment without slats or other air guide elements having to be provided.

Further advantages, features and design possibilities are evident from the following description of figures or of embodiments, which are not be understood as limiting.

In the drawings:

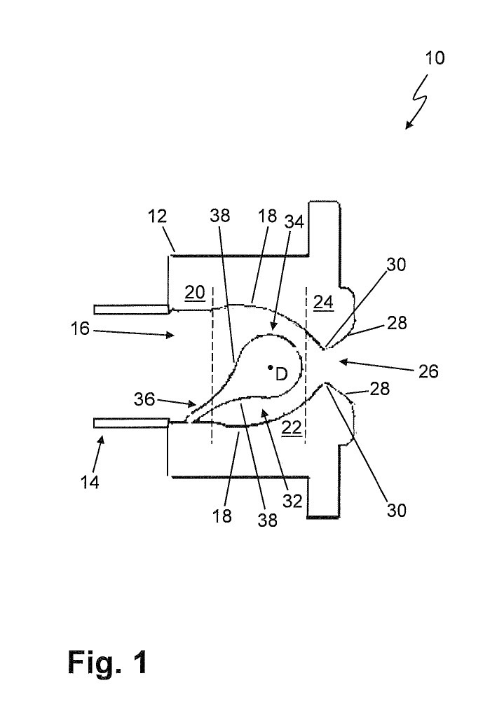

FIG. 1 shows a schematic illustration of an air vent with a displacement body of a first form of embodiment;

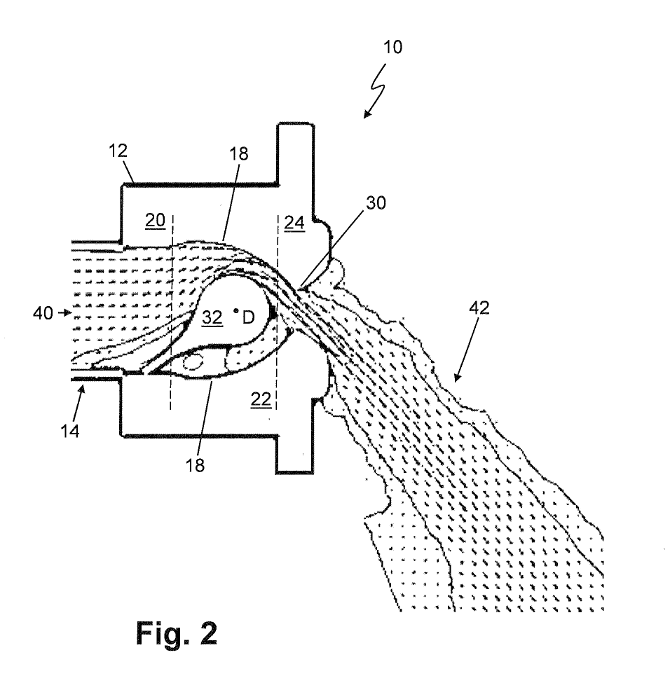

FIG. 2 shows a further schematic illustration of the air vent of FIG. 1;

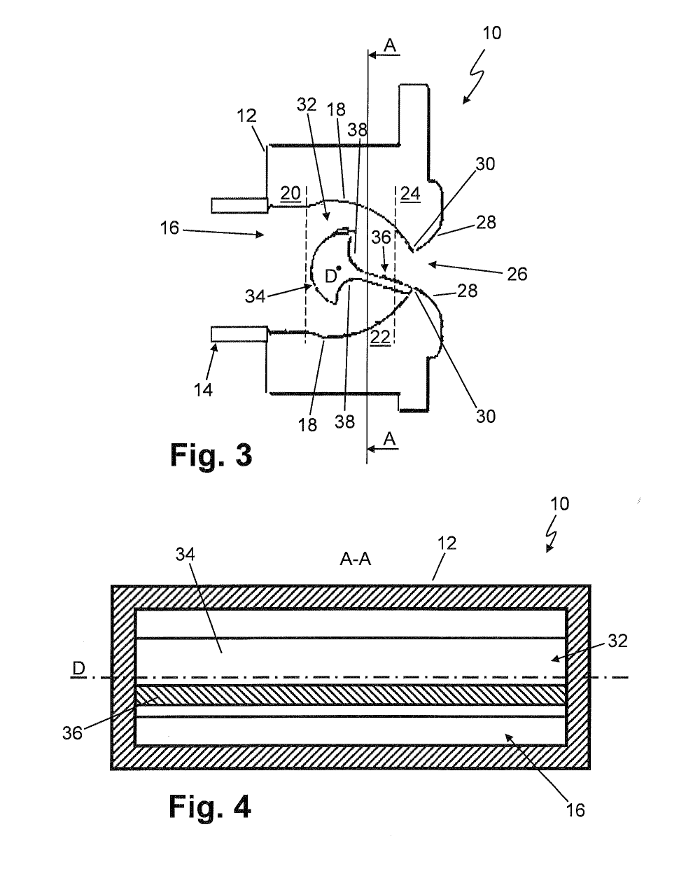

FIG. 3 shows a schematic illustration of an air vent with a displacement body of a second form of embodiment;

FIG. 4 shows a further schematic illustration of the air vent of FIG. 3; and

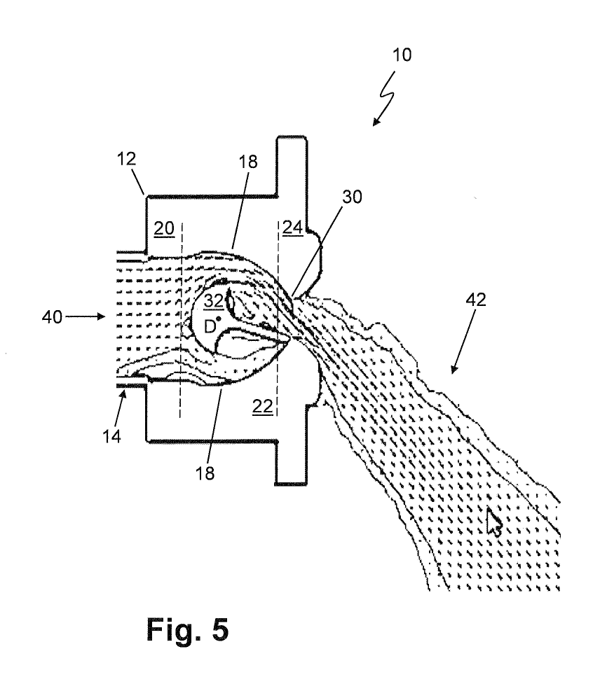

FIG. 5 shows yet a further schematic illustration of the air vent of FIG. 3.

In the figures, parts provided with the same reference numerals substantially correspond with one another insofar as nothing to the contrary is indicated. Moreover, description of components which are not significant for understanding of the teaching described herein has been dispensed with.

FIG. 1 shows a schematic illustration of an air vent 10 with a displacement body 32 in a first form of embodiment. The air vent 10 is constructed as a gap air vent and arranged in a vehicle dashboard. The air vent 10 comprises, apart from the displacement body 32, a housing 12 which encloses an air channel 16. The air channel 16 in the housing 12 is basically divided into three sections. The air channel 16 has an air inlet section 20, a centre section 22 and an air outlet section 24. The housing 12 is connected with a supply channel 14 by way of the air inlet section 20. Fresh air or climatised air from a vehicle air-conditioning installation or another ventilating device is supplied to the air vent 10 by way of the supply channel 14. In addition, a closing flap can be provided by way of which the quantity of supplied air and thus also the quantity of output air is controllable. Such a closing flap can also be provided in the second form of embodiment of an air vent 10 as shown in FIGS. 3 to 5.

The displacement body 32 is mounted in the region of the centre section 22 to be pivotable about a pivot axis D. The air vent 10 has an air outlet opening 26 in the air outlet section 24. The height of the air outlet opening 26 is substantially less than the height of the air channel 16 in the region of the centre section 22 and in the region of the air inlet section 20.

The cross-section of the air channel 16 increases starting from the air inlet section 20 towards the centre section 22 by a small amount, such as is illustrated in FIG. 1. Inflowing air thereby flows along channel walls 18. Starting from the centre section 22 the cross-section of the air channel 16 reduces until in the region of the air outlet section 24, in which the air outlet opening 26 is arranged. At the transitions 30 from the channel walls 18 to the outlet surfaces 28 the transitions 30 are formed in such a way that these provide an edge. However, the transitions 30 do not have a sharp edge, but can have a rounded transition. The transitions 30 have, for example, radii less than 5 millimetres.

The outlet surfaces 28 have a curvature. By way of the curvature 28 it is possible in the case of a neutral setting (not illustrated in FIG. 1) of the displacement body 32 to achieve—when a substantially straight air flow is output (to the right in the drawing of FIG. 1)—flow of the air along the outlet surfaces 28. Due to the curved formation of the outlet surfaces 28 flow of the air along these outlet surfaces 28 takes place with utilisation of Coanda effect. A more diffuse air flow can thereby be provided, in which case the issued air flow supplies a wide area with air by way of the air outlet opening 26.

The channel walls 18 similarly have a curvature which reduces the air channel 16 towards the air outlet opening 26. As a result, in the case of orientation of the displacement body 32 as shown in FIG. 1 the air flows along the upper channel wall 18, wherein the exiting air flow follows the orientation with utilisation of Coanda effect and thus an air flow in downward direction (in drawing direction of FIG. 1) is issued. The displacement body 32 has a first section 34 and a second section 36. The first section 34 is of substantially club-like configuration. The second section 36 is of substantially flat configuration and has a uniform thickness substantially over its entire length. The transitions 38 from the first section 34 to the second section 36 are formed to fall away flatly. The formation of the transitions 38 results, inter glia, in the orientation of the displacement body 32, wherein the second section 36 faces the air inlet section 20. Dividing up of the inflowing air flow in the air channel 16 can be set by way of the second section 36.

In the case of a central orientation, which is not illustrated in FIG. 1, of the displacement body there is a uniform dividing up of the entering air flow in direction towards the upper channel wall 18 and towards the lower channel wall 18. As a result, there is output of a substantially straight air flow. If pivotation of the displacement body 32 about the pivot axis D takes place as illustrated in FIG. 1, for example fully downwardly, so that the second section 36 bears against the lower channel wall then an entering air flow is guided entirely into the region between the first section 34 and the upper channel wall 18. As a result, the air flow is accelerated, since the cross-section through which the air flows is substantially reduced. The air flow output by way of the air outlet opening 26 follows the curvature of the upper channel wall 18 and is deflected downwardly at a high velocity (see FIG. 2). The curved configuration of the outlet surfaces 28 in that case assists downward deflection of the air flow with utilisation of Coanda effect.

The displacement body 32 can also be brought into intermediate settings, in which case a non-uniform distribution of the entering air flow to the upper region and the lower region can be undertaken. If, for example, air flows not only in the upper region, but also in the lower region, with the supplied air quantity in the upper region being significantly greater than in the lower region, the air flow which is issued via the lower region in the direction of the air outlet opening 26 causes a slight upward deflection of the output air flow.

The air vent 10 is constructed so that the side walls of the air vent 10 through which the pivot axis D runs form a flat surface. Such a curvature therefore prevails in the air channel 16 only in the opposite channel walls 18. The displacement body 32 is constructed in analogous manner so that the side surfaces of the displacement surfaces 32, through which the pivot axis D extends, represent a planar surface and lie against the flat channel walls of the air channel 16. The displacement body 32 therefore extends substantially over the entire width of the air channel 16 in the drawing direction. The cross-section of the air vent 12 is therefore substantially the same over its entire length, as illustrated in FIG. 1.

The air vent 10 is particularly suitable as a so-called gap air vent, which usually has a width of more than 300 millimetres. The displacement body 32 is controllable by way of a control wheel or an electric motor. For that purpose the displacement body 32 has, for example, bearing pins received in corresponding openings in the opposite planes of the channel walls of the air channel 16. At least one of the bearing pins is then coupled with the electric motor or the control wheel by way of gearwheels or other drive means. Activation of the electric motor by control commands via buttons or other control elements or activation by rotation of a control wheel produces pivotation of the displacement body 32. The displacement body 32 is thereby pivoted and changes the apportioning of the air flow, which is supplied by way of the air inlet section 22, to the upper section and the lower section. Deflection of the output air flow over a wide range can thereby be achieved in simple mode and manner.

Moreover, the air vent 10 has only a few components. The components such as displacement body 32, bearing pins and housing 12 can consist of, for example, a plastics material and can therefore be produced simply and economically in high batch numbers.

FIG. 2 shows a further schematic illustration of the air vent 10 of FIG. 1. The air flows 40 and 42 are illustrated in FIG. 2.

As can be inferred from the schematic illustration of FIG. 2, acceleration of the entering air flow 40 and downward deflection so that the output air flow 42 flows out substantially downwardly at high velocity take place by setting the displacement body 32 as illustrated in FIG. 2. As further illustrated in FIG. 2, there is, for example, downward deflection of the air flow by 45 degrees. Analogously thereto deflection of the air flow 42 upwardly through 45 degrees can also take place. If the outlet surfaces 28 have a different curvature or are of appropriate thin-wall construction it is possible to achieve larger air deflections.

FIG. 3 shows a schematic illustration of an air vent 10 with a displacement body 32 in a second form of embodiment. The second form of embodiment shown in FIG. 3 differs from the form of embodiment shown in FIGS. 1 and 2 in that the displacement body 32 has a larger second section 36, a smaller first section 34 and a different orientation.

The air vent 10 comprises, in correspondence with the air vent 10 of the first form of embodiment, a housing 12 with an air inlet section 20, a centre section 22 and an air outlet section 24, an air outlet opening 26 being provided in the air outlet section 24. The transitions 30 form an edge at which the output air flow 42 (see FIG. 5) correspondingly follows a curvature of opposite and curved channel walls 18. Equally, the air vent 10 has curved outlet surfaces 28 in the air outlet section 24. The air vent 10 is connected in the air inlet section 20 with a supply channel 14 by way of which supplied air flows into the air channel 16.

The displacement body 32 is mounted to be pivotable about the pivot axis D. Analogously to the first described form of embodiment, the displacement body 32 can be pivoted by way of a control wheel or an electric motor. The second section 36 of the displacement body 32 has a greater length than the displacement body 32, which is shown in FIG. 1 and FIG. 2, of the first form of embodiment. In addition, the transitions 38 between the first section 34 and the second section 36 are formed to drop away strongly. The first section 34 has a substantially semicircular cross-section. Inflowing air thereby flows along the first section 34 and by virtue of the curvature of the first section 34 and the curvature of the channel walls 18 passes to the air outlet opening 26. By way of the second section 36, the air channel 16 can achieve blocking of the air channel 16, for example as shown in FIG. 3, in the lower region. Due to the formation of the transitions 38 only a small amount of turbulence is induced in the air flow.

In the case of the setting of the displacement body 32 shown in FIG. 3 the air supplied by way of the air inlet section 20 is very strongly accelerated in the region of the centre section 22 between the first section 34 and the upper channel wall 18 and flows along the channel wall 18 so that an air flow 42 is issued which is directed downwardly.

If the displacement body 32 were pivoted in counter-clockwise sense, the second section 36 would free an air flow between the first section 34 of the displacement body 32 and the lower channel wall 18 so that depending on the setting of the second section 36 an air deflection of the output air flow upwardly is achieved. If the second section 36 is disposed substantially in a middle setting, in which case the second section 36 is in a horizontal position, there is substantially no deflection of an output air flow and the air flow flows in the drawing direction of FIG. 3, substantially rectilinearly to the right out of the air outlet opening 26.

By virtue of the formation of the first sections 34 as club-like sections 34 the displacement body 32 of the first form of embodiment and the displacement body 32 of the second form of embodiment produce, in addition to the air deflection, acceleration of the output air flow, since the cross-section of the air channel 16 is substantially reduced.

FIG. 4 shows a further schematic illustration of the air vent 10 of FIG. 3.

FIG. 4 shows a section through the air vent 10 of FIG. 3 along the line A-A. The displacement body 32 has substantially the same width as the air channel 16. Deflection of the outflowing air therefore takes place substantially only downwardly and upwardly. An electric motor or a control wheel is coupled at one of the side walls of the housing 12 to at least one bearing pin, by way of which the displacement body 32 is mounted to be rotatable about the pivot axis D. By way of that, pivotation of the displacement body 32 for change in the outflow direction can be carried out.

FIG. 5 shows yet another schematic illustration of the air vent 10 of FIG. 3 of the second form of embodiment. Analogously to the illustration of the air vent 10 of the first form of embodiment in FIG. 2 blocking of an air flow between the displacement body 32 and the lower channel wall 18 occurs when the displacement body 32 is pivoted. In order that there is no issue of air or influencing of the outflowing air flow 42 a seal can be arranged at the edge by which the second section 36 of the displacement body 32 bears against the channel walls. Similarly, the displacement body 32 of the first form of embodiment can have a seal at the second section 36. Seals can be formed by, for example, rubber lips or by a silicone coating.

As illustrated in FIG. 5, deflection of an entering air flow 40 by the displacement body 32 can be achieved, in which case the output air flow 42 is deflected by more than 45 degrees. An air deflection of that kind could previously be achieved only by way of slats directly arranged in the region of the air outlet opening. In the case of the air vent 10, the large deflection is achieved by the acceleration of the exiting air flow 42 in the region of the centre section 22 and of the air outlet section 24 by the channel narrowing as well as by the displacement body 32. The curved formation of the outlet surfaces 28 in that case assists air deflection.

An advantage of the construction of the air vent 10 (particularly the form of embodiment illustrated in FIG. 1 and FIG. 2) consists in that no slats are visible from the front (‘concealed’ or ‘invisible’ air vent), not even those needed for vertical air deflection in the background (vertical slats are not illustrated in the figures). Moreover, through segmentation of club-like displacement bodies even curved or three-dimensional gaps are supplied with air.

### REFERENCE NUMERAL LIST

10 air vent

12 housing

14 supply channel

16 air channel

18 channel wall

20 air inlet section

23 centre section

24 air outlet section

26 air outlet opening

28 outlet surface

30 transition

32 displacement body

34 section

36 section

38 transition

40 air flow

42 air flow

D pivot axis

1-10. (canceled)

11. An air vent with a device for controlling an air flow, wherein the air vent is formed as a gap vent and has a small height by comparison with its width, comprising a housing surrounding an air channel at least in a section and a displacement body pivotably mounted in the housing, wherein
the housing has an air inlet section, a centre section and an air outlet section and the cross-section of the air channel reduces going from the centre section towards the air outlet section,
the displacement body is pivotable about a pivot axis, which extends parallel to an air outlet opening provided in the air outlet section, and has a lobar form at least in a section in the cross-section of the air vent perpendicular to the pivot axis,
the displacement body is arranged completely within the air channel and
the displacement body extends over the width of the air vent.

12. The air vent according to claim 11, wherein the displacement body has at least a first section and a second section, wherein the first section is of lobar form and the second section has a thickness which is smaller by comparison with the first section.

13. The air vent according to claim 12, wherein the transition between the first section and the second section of the displacement body falls away flatly or steeply.

14. The air vent according to claim 12, wherein the pivot axis extends through the first section of the displacement body.

15. The air vent according to claim 12, wherein the first section of the displacement body is arranged to face the air inlet section or the air outlet opening.

16. The air vent according to claim 11, wherein the displacement body is of hollow or solid construction.

17. The air vent according to claim 11, wherein the air outlet section has, in the region of the air outlet opening, transitions with an edge.

18. The air vent according to claim 11, wherein curved outlet surfaces adjoin the air outlet opening.

19. The air vent according to claim 11, wherein the air channel has a smaller diameter in the region of the air inlet section than the air channel in the region of the centre section.

20. The air vent according to claim 11, wherein the displacement body is coupled with an electric motor.

21. The air vent according to claim 13, wherein the pivot axis extends through the first section of the displacement body.

22. The air vent according to claim 13, wherein the first section of the displacement body is arranged to face the air inlet section or the air outlet opening.

23. The air vent according to claim 14, wherein the first section of the displacement body is arranged to face the air inlet section or the air outlet opening.

24. The air vent according to claim 12, wherein the displacement body is of hollow or solid construction.

25. The air vent according to claim 12, wherein the air outlet section has, in the region of the air outlet opening, transitions with an edge.

26. The air vent according to claim 12, wherein curved outlet surfaces adjoin the air outlet opening.

27. The air vent according to claim 12, wherein the air channel has a smaller diameter in the region of the air inlet section than the air channel in the region of the centre section.

28. The air vent according to claim 12, wherein the displacement body is coupled with an electric motor.
